(19) United States
(12) Patent Application Publication
(10) Pub. No.: US 2006/0265408 A1
(43) Pub. Date: Nov. 23, 2006

(54) System and method for reconciling ownership and discovered asset information

(75) Inventor: James M. Pini, Venetia, PA (US)

Correspondence Address: BAKER BOTTS L.L.P., 2001 ROSS AVENUE, SUITE 600, DALLAS, TX, 75201-2980, US

(73) Assignee: Computer Associates Think, Inc.

(21) Appl. No.: 11/134,819

(22) Filed: May 20, 2005

(51) Int. Cl. G06F 7/00; G06F 17/00

(52) U.S. Cl. 707/100

(57) ABSTRACT

A method of managing discovered information and ownership information for a plurality of assets includes defining matching rules for matching a plurality of discovery records with a plurality of ownership records. The discovery records include information about a plurality of assets discovered during a network scan. The ownership records include information about the plurality of assets entered when the assets were acquired. The matching rules specify a first field included in each of the plurality of discovery records to be matched with a second field included in each of ownership records. The matching rules are applied to match one of the plurality of discovery records to one of the plurality of ownership records and create a matched record. The matched record includes a first pointer to the one of the plurality of discovery records and a second pointer to the one of the plurality of ownership records.

### TECHNICAL FIELD OF THE INVENTION

This invention relates generally to enterprise management and more specifically to a system and method for reconciling ownership and discovered asset information.

### BACKGROUND OF THE INVENTION

An aspect of enterprise management involves monitoring and managing hardware assets, such as computers, workstations, routers, etc., across the enterprise. These hardware assets may be geographically dispersed and may be assigned to different subgroups of the enterprise. Certain information about a particular hardware asset can be gathered by examining the hardware asset over a computer network. This data is known as discovery data. If the hardware asset is a computer, discovery information may include, for example, the computer's serial number, the computer's name on the network, the computer's place in the network hierarchy, the amount of memory the computer contains, the speed of the computer's processor, or the operating system running on the computer.

Another set of information pertaining to enterprise assets is known as ownership information. This is often information obtained and input at the time of purchase or lease of the asset. Using a computer as an example again, ownership data may include the manufacturer of the computer, the vendor or lessor of the computer, the serial number of the computer, licensing information on the software contained on the computer, and cost information.

Discovery information and ownership information may be maintained in separate databases. To access the discovery and ownership information for a particular asset, separate database records may need to be searched. Further, to update or change information pertaining to an asset, two records may need to be changed. Likewise, when an asset is sold or disposed of, the record must be removed from both databases. In the case of some assets, particularly older assets, discovery information may exist but ownership information may not. This may not be known until after a fruitless search through the ownership database to find information pertaining to the asset. Maintaining two databases with overlapping information that are not accessible or modifiable from a single portal can be cumbersome and time consuming.

### SUMMARY OF THE INVENTION

In accordance with the teachings of the present invention, the disadvantages and problems associated with managing separate ownership and discovery records pertaining to a single asset have been substantially reduced or eliminated. In particular, the system and method described herein provide for matching, indexing, and management of corresponding discovery and ownership records.

In accordance with one embodiment of the present invention, a method of managing discovered information and ownership information for a plurality of assets includes defining matching rules for matching a plurality of discovery records with a plurality of ownership records. The plurality of discovery records include information about a plurality of assets discovered during a network scan. The plurality of ownership records include information about the plurality of assets entered when the assets were acquired. The matching rules specify a first field or set of fields included in each of the plurality of discovery records to be matched with a second field or set of fields included in each of the plurality of ownership records. The matching rules are applied to match one of the plurality of discovery records to one of the plurality of ownership records and create a matched record. The matched record includes a first pointer to the one of the plurality of discovery records and a second pointer to the one of the plurality of ownership records. The one of the plurality of discovery records includes discovered information of an asset and the one of the plurality of ownership records includes ownership information of the asset.

In particular embodiments, applying the matching rules includes comparing a first value in the first field with each of a plurality of entries in a translation table to determine if the first value is the same as any one of the entries in the translation table, wherein each of the plurality of entries in the translation table are a variant of a second value in the second field. Other particular embodiments may include repeating applying the matching rules to match other ones of the plurality of discovery records to other ones of the plurality of ownership records to create a plurality of matched records, and generating a registration table listing each of the plurality of matched records.

Technical advantages of certain embodiments of the present invention include the ability to match, alter, and reconcile discovery and ownership records pertaining to a single asset from a web-based interface. The reconciler engine correlates separate discovery and ownership records for a single asset into a matched record. The reconciler engine may also gather information about discovery and ownership records that are candidates for matching so that this information can be manually reviewed and approved. The matched record may be integrated into a registration table that may be made available to external applications. A web-based graphical user interface may access the registration table and allow a user to view the discovery and ownership records from a single portal and potentially from any location with access to a web browser.

Another technical advantage of particular embodiments of the present invention may include the ability to create or update ownership records based on the information available in the discovery records. When a machine is upgraded, this information will often be reflected in the discovery record following a network scan. The updated information in the discovery record can then be used to update the ownership record. Likewise, if there is not an existing ownership record corresponding to a particular discovery record, an ownership record may be created and populated with information from the discovery record.

An additional technical advantage of particular embodiments of the present invention may include the ability to specify subdivisions of enterprise assets upon which to perform particular functions. The subdivision or subdivisions of enterprise assets may be specified by using filters. The filters may be built-in, commonly used filters, or they may be user-defined to suit a specific user need. The functions may be executed faster when the number of records is reduced, and the output may be more useful as it is limited to pertinent, specified assets.

Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

To provide a more complete understanding of the present invention and the features and advantages thereof, reference is made to the following description, taken in conjunction with the accompanying drawings, in which:

FIG. 1 illustrates one embodiment of a system to reconcile discovery records and ownership records including a reconciler engine in communication with a discovery database, an ownership database, and a user interface platform;

FIG. 2 is a flowchart illustrating a method to reconcile discovery records with corresponding ownership records;

FIG. 3 illustrates a matching module of the reconciler engine of FIG. 1 for matching discovery records with ownership records;

FIG. 4 is a flowchart illustrating steps performed by the matching module of FIG. 3 to match discovery records with corresponding ownership records;

FIG. 5 illustrates one embodiment of a registration table that may be created by the matching module of FIG. 3;

FIG. 6 illustrates one embodiment of an add module of the reconciler engine of FIG. 1 to add ownership records corresponding to discovery records that are unmatched with ownership records;

FIG. 7 is a flowchart illustrating steps performed by the add module of FIG. 6 to create ownership records corresponding to discovery records which were unmatched with ownership records;

FIG. 8 illustrates one embodiment of a change module of the reconciler engine of FIG. 1 for changing fields of ownership records that correspond to fields of discovery records that have been updated;

FIG. 9 is a flowchart illustrating steps performed by the change module of FIG. 8 to modify fields of the ownership records corresponding to modified fields of discovery records;

FIG. 10 illustrates one embodiment of a delete module of the reconciler engine of FIG. 1 to delete or remove from a notification list ownership records or discovery records which were previously matched but no longer have a matching ownership or discovery record; and

FIG. 11 is a flowchart illustrating steps performed by the delete module of FIG. 10 to delete discovery or ownership records.

### DETAILED DESCRIPTION OF THE INVENTION

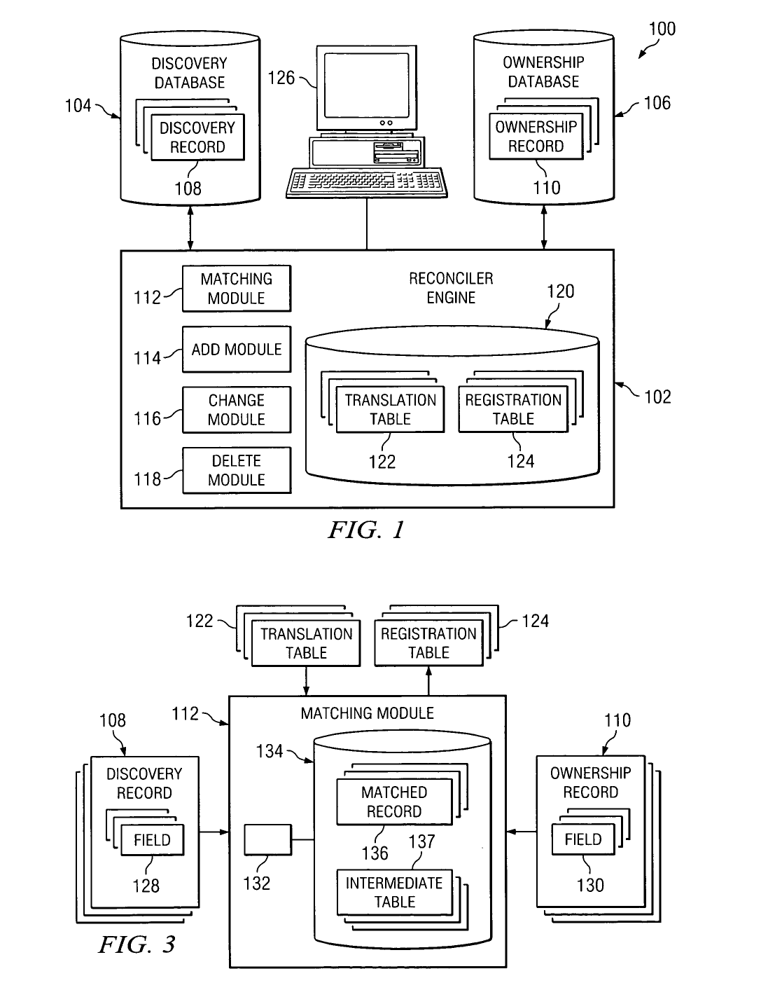

FIG. 1 illustrates a system 100 for reconciling separately stored information records. System 100 may correlate the separate records and add, modify, or delete the registration records for any particular asset to reconcile the records for the asset. Reconciler engine 102 collects data from discovery database 104 and ownership database 106. The data is in the form of discovery records 108 from discovery database 104 and ownership records 110 from ownership database 106. Discovery records 108 and ownership records 110 will be reconciled with their corresponding counterpart. To accomplish the reconciliation process, reconciler engine 102 includes a matching module 112, an add module 114, a change module 116, a delete module 118, and a memory 120.

A specific enterprise asset, such as a computer or a workstation, may have both a discovery record 108 and an ownership record 110. The asset's discovery record 108 may include data collected by inventory discovery software during a scan of the network. Some examples of discovery data may include: the asset's serial number, the amount of memory the asset includes, the asset's components, the name or designator of the asset on the network, the asset's location on the network, the asset's operating system, applications running on the asset, or any other discoverable information. The asset's ownership record 110 may include information collected and recorded at the time the asset was acquired. Ownership information may be information that is not readily discernable by examining the asset. Some examples of ownership information may include: the asset's serial number; whether the asset is leased or owned, the vendor the asset was purchased from, the asset type, the asset's manufacturer, the price paid for the asset, or any other relevant information.

In a particular embodiment, ownership database 106 may be, for example, a database created by Unicenter Asset Portfolio Management available from Computer Associates. In an alternative embodiment, ownership database 106 may be practically any database containing ownership records. Discovery database 104 may be, for example, a database created by Unicenter Asset Management available from Computer Associates, System Management Server (SMS) available from Microsoft, Tivoli available from IBM, Asset Insight available from Tangram, TS.Census available from Tally Systems, or practically any asset discovery system. Discovery database 104 may also include multiple databases created using one or more of the above mentioned asset discovery tools. In this manner, reconciler engine 102 may be capable of reconciling enterprise assets independent of the service used to collect and store the asset information.

Matching module 112 is responsible for matching a discovery record 108 corresponding to a particular asset with an ownership record 110 also pertaining to the particular asset. Matching module 112 may use translation table 122 to match discovery record 108 with ownership record 110. Translation table 122 may include various alterations or common variants of information stored in discovery record 108 and/or ownership record 110 to aid in matching the records when the information is not precisely the same in each record. Once each discovery record 108 has been matched with a corresponding ownership record 110, or an attempt has been made to match each record, matching module 112 may store matched records in registration table 124.

Add module 114 may be invoked to add an ownership record 110 for an asset which has a discovery record 108, but does not yet have a corresponding ownership record 110. Add module 114 may compare the entries in registration table 124 with discovery records 108. Discovery records 108 which have not yet been matched with an ownership record 110 may have an ownership record 110 created that corresponds to the discovery record 108.

Change module 116 may be used to update the information included in an ownership record 110 that has already been matched with a discovery record 108. Change module 116 may use the registration tables 124 to examine matches between discovery records 108 and ownership records 110. For each matched record, change module 116 may examine the discovery record 108 to determine if it includes information which is different than the information included in ownership record 110. If change module 116 finds that information in discovery record 108 does not match information in a corresponding ownership record 110, ownership record 110 may be updated to include the information reflected in discovery record 108.

Delete module 118 may be used to indicate discovery records 108 or ownership records 110 that were previously matched but no longer have a corresponding discovery record 108 or ownership record 110. When a previously matched record is found to be missing a discovery record 108 or ownership record 110, delete module 118 may delete the broken link information for the ownership record 110 or discovery record 108 so that those records will be ignored by system 100 in the future.

System 100 also includes a platform 126 with a graphical user interface. Platform 126 may be used to implement, control, and schedule the various functions of reconciler engine 102. Platform 126 may also display to a user the output of reconciler engine 102 and allow a user to review and change the output of reconciler engine 102 or the various modules 112-118.

While the various components of system 100 and reconciler engine 102 will be described in more detail below, system 100 and reconciler engine 102 may include many different combinations of hardware or software for executing the described functionality. Furthermore, the components of system 100 and reconciler engine 102 may be located together or be geographically dispersed. Any of the components of system 100 or reconciler engine 102 may be configured to communicate over a network, including, but not limited to, a local area network (LAN) or a wide area network (WAN). Discovery database 104 has been illustrated as distinct from ownership database 106, but the databases may co-reside on a single memory device, be subrecords of a large database, or be intermingled records of a single database.

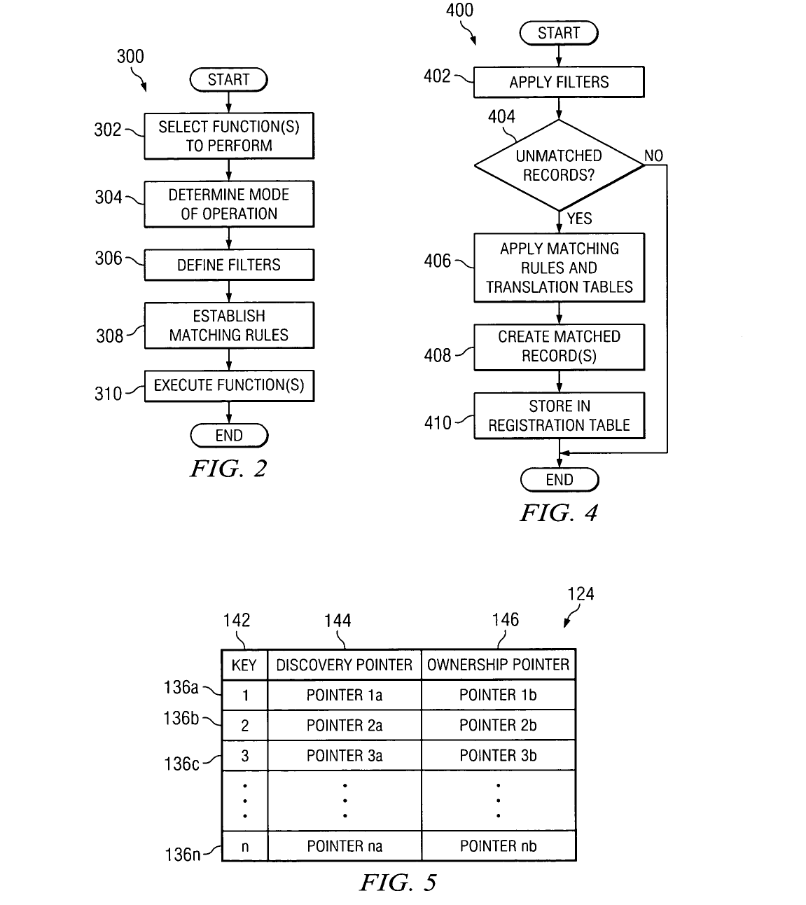

FIG. 2 is a flowchart 300 illustrating steps to reconcile discovery records 108 and ownership records 110. At step 302, one or more functions to be performed are selected. The functions to be performed may include matching records, adding records, changing records, or processing deleted records. Selecting the function or functions to perform may include a user of platform 126 instructing reconciler engine 102 on which functions to perform. Selecting the functions to perform may also be accomplished by an automatic scheduling program. Platform 126 may be used to define a schedule of functions to perform. The automatic scheduling program may then select the functions to be performed at times defined in the schedule of functions.

At step 304, the mode of operation is determined. The mode of operation may include manual or automatic. The specific implications of choosing automatic or manual mode for any particular function will be discussed in more detail below. Generally, automatic mode allows reconciler engine 102 to automate the various functions without further user input, while manual mode allows a user to verify the output of the various functions prior to accepting or saving the output.

At step 306, filters are defined to instruct reconciler engine 102 on which discovery records 108 and ownership records 110 are to be reconciled. An enterprise may potentially have thousands or hundreds of thousands of assets that each have a discovery record 108 and an ownership record 110. It may therefore be overly burdensome to perform any particular function on each asset's records at one time. Filters may allow particular subsets of asset records to be defined as the target of reconciliation. The filters may subdivide asset records based upon predefined, built-in filters to reconciler engine 102, or practically any user-defined filter. Example built-in filters may include: business information, geographic information, asset information, and/or user information. Business information may include, for example, all sales asset records or all management asset records. Geographic information may include, for example, asset records for the Dallas office or asset records for all North American operations. Asset information may include, for example, asset records for all laptops or asset records for all computers running the Windows 2000 operating system. User information may include, for example, records for assets used by personnel with a security clearance above a particular level. These filters as well as many other built-in or user-defined filters may be used to subdivide an enterprise's records to speed the reconciliation process, to make the output of the reconciliation process manageable for human review, or to limit output to only relevant assets. Filters may also be used to allow asset records to be seen by only those parties responsible for the assets or parties authorized to manage and view the assets. Further, filters may operate at the asset level and be defined to explicitly exclude a particular asset, assets, or groups of assets from consideration. If particular asset records should never be considered by reconciler engine 102, the assets may be added to a list of assets to be ignored. Reconciler engine may consult this list and exclude any assets on the list from consideration prior to performing any functions on the asset's records.

Step 308 includes establishing rules for matching discovery records 108 and ownership records 110. One or more matching rules may be used to instruct matching module 112 of reconciler engine 102 on how to match discovery records 108 and ownership records 110. Discovery records 108 and ownership records 110 may have various overlapping fields, such as, for example, serial number, machine name, and/or machine type. One or more of these overlapping fields of discovery records 108 and ownership records 110 may be used to determine that a particular discovery record 108 matches an ownership record 110. Potentially any number of matching rules may be utilized to achieve a desired comfort level that a matched discovery record 108 and ownership record 110 correspond to the same enterprise asset. At step 310, the function selected in step 302 are executed. Details of the execution of the various functions will be outlined below in more detail. If, at step 302, more than one function has been selected to be performed, step 304—determining the mode of operation, step 306—defining filters, and step 308—establishing matching rules, may be performed for each function selected in step 302.

FIG. 3 illustrates matching module 112. Matching module 112 matches discovery records 108 with ownership records 110 to create matched records 136. Matched records 136 may then be saved in a registration table 124.

Matching module 112 may include a processor 132 and a memory 134. Processor 132 may be operable to match a value in field 128 of discovery record 108 with a value in field 130 of ownership record 110. Fields 128 and 130 may be any fields that are included in either discovery record 108 or ownership record 110. Common fields that may exist in both discovery record 108 and ownership record 110 may include, but are not limited to, serial number, asset type, asset name, and asset manufacturer. When one or more fields 128 have been matched with one or more fields 130, processor 132 may create a matched record 136 in memory 134 and save the matched record in registration table 124.

Matching module 112 may use translation tables 122 to determine if a value in field 128 of discovery record 108 matches a value in field 130 of ownership record 110. Values in fields 128 and fields 130 may be equivalent values but may not be the exact same value. For instance, when the fields 128 and 130 being compared include a value for a particular operating system name, the value in field 130 may have an extra space that is not included in the value for the operating system name entered in field 128. In this regard, the value of fields 128 and 130 are equivalent, but not the same. In another example, a manufacturer's name may include corporate entity status designators, such as Corp. or Inc., in some fields but not in others. To avoid missing matches based on differences in the way field values are entered, translation table 122 includes variants of the values in field 128 and/or field 130. A value in field 128 or 130 may be compared with the corresponding field value to determine if the fields contain the same value. If the values are not the same, each entry in translation table 122 corresponding to field 128 may be compared against the value in field 130. If any of the entries in translation table 122 corresponding to the value in field 128 match the value in field 130, the value in field 128 is an equivalent of the value in field 130, and discovery record 108 may match ownership record 110. The same process may also be used to check equivalents of the value in field 130 against the value of field 128. Alternatively, a particular translation table 122 may contain equivalents for a particular field, such as a manufacturer's name field, and fields 128 and 130 may be determined to be matching fields when the values of fields 128 and 130 are both present as entries in translation table 122.

Once each of the matching rules have been satisfied by finding an equivalent of each field 128 or 130 implicated by the matching rules in a corresponding field 128 or 130, a matched record 136 is created indicating the location of the matched discovery record 108 in discovery database 104 and the location of the matched ownership record 110 in ownership database 106. This matched record 136 may be stored temporarily in memory 134. If the mode of operation for the matching function is automatic, this matched record 136 may be automatically saved to the registration table 124. If the mode of operation for the matching function is manual, the matched records 136 may be saved in an intermediate table 137 and presented to a user through platform 126 for approval or re-matching prior to being saved in registration table 124. Intermediate table 137 may be a temporary table that is overwritten as needed.

Once matching module 112 has applied the matching rules to attempt to match each discovery record 108 and each ownership record 110, a listing of unmatched discovery records and unmatched ownership records may be created and stored in intermediate table 137. This listing may be presented through platform 126 to allow a user to match the unmatched discovery records 108 with ownership records 110. If a user is able to create matches, a matched record 136 is created and stored in registration table 124.

FIG. 4 is a flowchart 400 illustrating the matching function performed by matching module 112. At step 402, the filters defined in step 306 of FIG. 2 are applied to select the discovery records 108 to be matched with ownership records 110. Any enterprise records excluded from the scope of the filters will not be matched.

At step 404, matching module 112 checks for unmatched records. This check may be performed by checking the filtered discovery and ownership records 108 and 110 against the registration table 124. If each discovery record 108 and ownership record 110 is included in registration table 124, all of the assets defined by the filters have already been matched and no matching is performed. If unmatched records exist, execution proceeds to step 406.

At step 406, the matching rules and translation tables are applied to match discovery records 108 and ownership records 110. As discussed above, the values of various fields 128 of discovery records 108 are compared with the values of corresponding fields 130 of ownership records 110 in order to match discovery records 108 and ownership records 110. Once discovery records 108 and ownership records 110 have been matched, a matched record 136 is created at step 408. The matched records 136 are then stored in registration table 124.

FIG. 5 illustrates a simplified textual representation of the information which may be contained in registration table 124. Registration table 124 includes matched records 136 (indicated by 136a-n). As illustrated, a matched record 136 includes a key 142, a discovery pointer 144, and an ownership pointer 146. Key 142 is an indication of the matched record's placement within registration table 124. The discovery pointer 144 is a pointer to a location in discovery database 104 that contains the specific discovery record 108 of matched record 136. Likewise, ownership pointer 146 is a pointer to a specific location in ownership database 106 containing the ownership record 110 of the matched record 136. A single registration table 124 is created for all enterprise assets that have been matched. Additionally, the registration table 124 may be updated each time the matching function is run with a different set of filters.

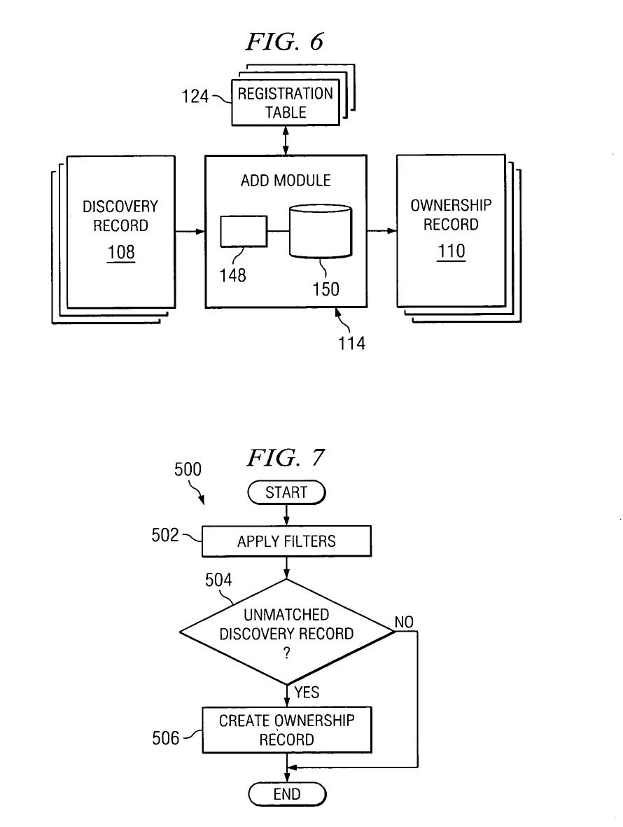

FIG. 6 illustrates add module 114. Add module 114 may include a processor 148 and a memory 150. Processor 148 of add module 114 may be operable to locate discovery records 108 that do not have corresponding ownership records 110. Add module 114 may then create ownership records 110 that correspond to the unmatched discovery records 108.

In order to create an ownership record 110, add module 114 may first examine registration tables 124. If all discovery records 108 include a match in registration table 124, then no ownership records 110 need to be added. If, however, there are discovery records 108 that are not included in a matched record 136 in registration table 124, and those discovery records 108 are not able to be matched with an ownership record 110, add module 114 creates an ownership record 110 from the information in discovery record 108. The new ownership record 110 may be populated with overlapping information from discovery record 108. In addition, several ownership record properties, such as the asset type, status, and contact, may be set based upon options specified by the user. In a particular embodiment, add module 114 will then update registration table 124 to include discovery record 108 and ownership record 110 in a newly created matched record 136. In an alternative embodiment, the registration table 124 may not be updated until the next execution of the matching function.

Execution of the add function in automatic mode results in a new ownership record 110 being created for each unmatched discovery record 108. If the add function is being executed in manual mode, the unmatched discovery records will be presented to a user to allow the user to determine which discovery records 108 should have new ownership records 110 created. The new ownership records 110 are stored in ownership database 106.

FIG. 7 is a flowchart 500 illustrating the add function performed by add module 114. The filters defined in step 306 of FIG. 2 are applied in step 502. From the subset of enterprise assets identified in step 502, at least one unmatched discovery record 108 may be identified at step 504. If no unmatched discovery records 108 are identified, the add function ends. If at least one unmatched discovery record 108 is identified, a corresponding ownership record 110 is created at step 506. Steps 504 and 506 may be repeated for each unmatched discovery record 108.

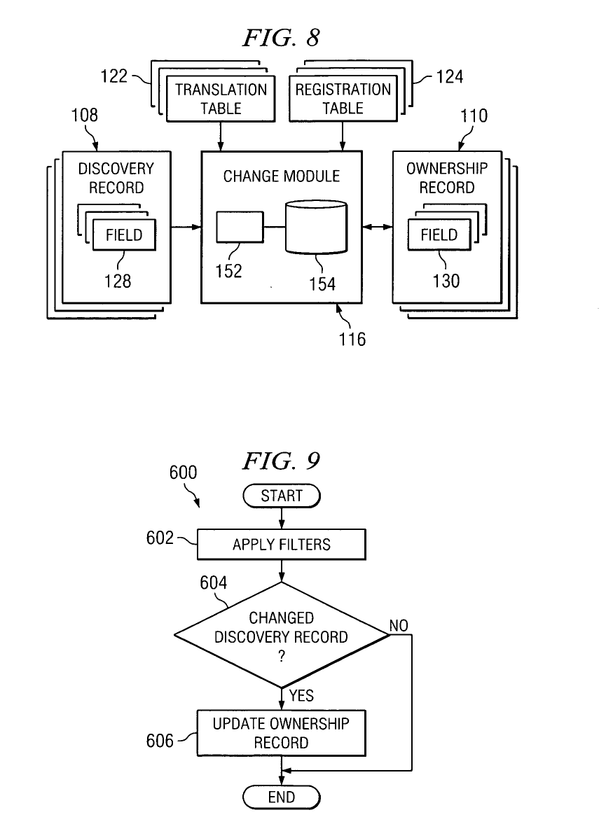

FIG. 8 illustrates change module 116. Change module 116 may include a processor 152 and a memory 154. Change module 116 inspects registration table 124 for matched records 136. For all of the matched records 136, or for specific matched records 136 that have been identified, change module 116 may scan fields 128 of discovery record 108 and compare them with corresponding fields 130 of ownership record 110. If a discrepancy is found between a field 128 and a corresponding field 130, the value in field 130 may be updated to reflect the value in field 128. When scanning for discrepancies between field 128 and field 130, change module 116 may utilize translation tables 122. If the value in field 130 matches an equivalent value in translation table 122, then there is no discrepancy between field 128 and field 130. In particular embodiments, the value in field 130 may be updated to reflect the value in the translation table entry for field 128. Any fields 130 with a corresponding field 128 may potentially be updated in this manner.

FIG. 9 is a flowchart 600 illustrating the change function performed by change module 116. The filters defined at step 306 of FIG. 2 are applied at step 602. For the subset of enterprise assets identified at step 602, discovery records 108 and ownership records 110 are scanned for discrepancies. If at least one changed discovery record 108 is found at step 604, the corresponding ownership record 110 is updated at step 606. If no changed discovery records 108 are found at step 604, the change function ends. Steps 604 and 606 may be repeated for each ownership record 110 that does not match its corresponding discovery record 108. In a particular embodiment, only specific fields 128 of discovery records 108 may be compared against fields 130 of ownership record 110. In this embodiment, only the compared fields 130 may be updated to reflect the value of the corresponding field 128. The fields 128 or 130 may be user selected from a pre-defined list.

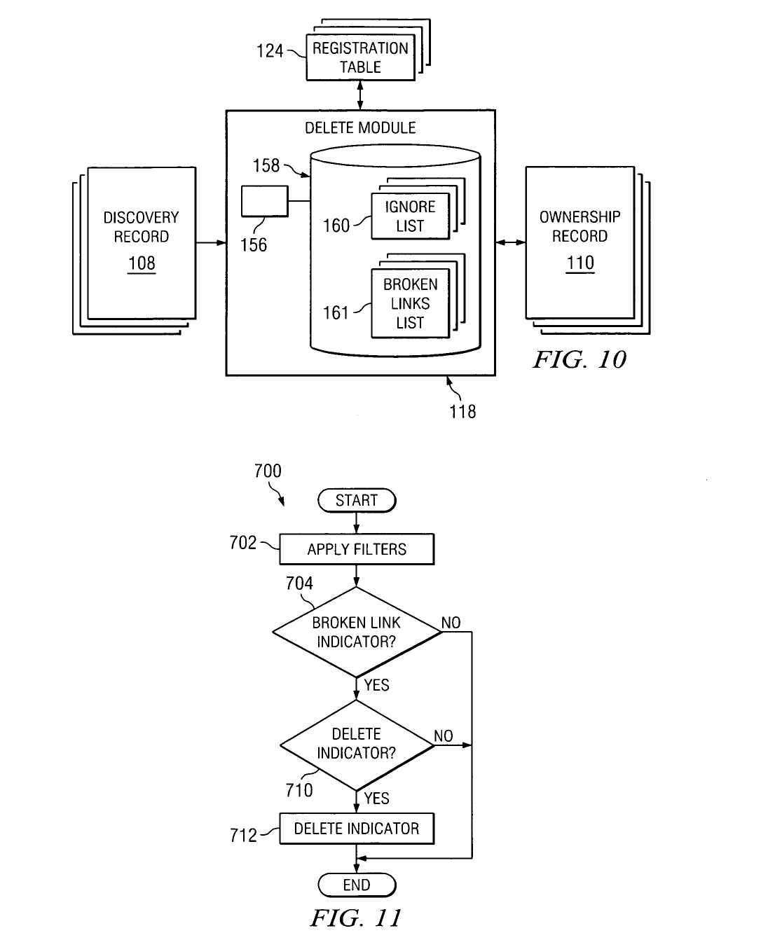

FIG. 10 illustrates delete module 118. Delete module 118 may include a processor 156 and a memory 158. Delete module 118 may scan for discovery records 108 and ownership records 110 to identify discovery records 108 or ownership records 110 that no longer have a corresponding ownership or discovery record, respectively. Delete module 118 will accomplish this by searching a broken links list 161. Broken links list 161 contains a listing of broken link indicators created by the deletion of a discovery record 108 or ownership record 110. When a discovery record 108 or ownership record 110 is deleted, a broken link indicator is added to broken links list 161. When a matched record 136 is identified with a broken link indicator from broken links list 161, several actions may be taken. If the ownership record 110 in a matched asset pair was deleted, the corresponding discovery record 108 may be presented to a user of platform 126 to make the user aware of the missing ownership record 110. If the user is aware of the missing ownership record 110 and does not wish to be notified of the missing record again, the user may remove the broken link indicator from broken links list 161 and possibly add the asset to the ignore list 160.

If the discovery record 108 in a matched asset pair is deleted, a user may be notified that the corresponding ownership record 110 may be deleted or added to the ignore list 160. When an unmatched ownership record 110 that was previously matched is identified, and the mode of operation is automatic, the broken link indicator corresponding to the ownership record 110 may automatically be removed from broken links list 161. If the mode of operation is manual, the ownership records 110 without corresponding discovery records 108 may be presented to a user through platform 126. The user may decide to delete ownership record 110 when, for instance, the discovery record 108 corresponds with an asset that has been disposed of. The user may choose to remove the broken link indicator from broken links list 161 when the user is aware that the corresponding discovery record 108 corresponds to an asset that is temporarily unavailable, such as a machine that is being repaired, or an undocked laptop.

FIG. 11 is a flowchart 700 illustrating the delete function performed by delete module 118. At step 702, the filters defined in step 306 of FIG. 2 are applied. If at least one broken link indicator is discovered in broken links list 161, it is identified in step 704. If there are no broken link indicators, the delete function ends. If there is at least one broken link indicator, a decision is made to delete the broken link indicator at step 710. If the broken link indicator is to be deleted, it is deleted at step 712. If the broken link indicator is not to be deleted, then the delete function ends for that record. Steps 704 to 712 may be repeated for each broken link indicator.

Matching module 112, add module 114, change module 116, and delete module 118 have each been illustrated and described above as having a processor and a memory. Each of the modules may have a distinct processor 132, 148, 152, and 156, and distinct memories 134, 150, 154, and 158, or the modules may share a processor or grouping of processors and a memory or grouping of memories.

Numerous other changes, substitutions, variations, alterations and modifications may be ascertained by those skilled in the art and it is intended that the present invention encompass all such changes, substitutions, variations, alterations and modifications as falling within the spirit and scope of the appended claims. Moreover, the present invention is not intended to be limited in any way by any statement in the specification that is not otherwise reflected in the claims.

What is claimed is:

1. A method of managing discovered information and ownership information for a plurality of assets, comprising:
defining matching rules for matching a plurality of discovery records with a plurality of ownership records, wherein:
the plurality of discovery records include information about a plurality of assets discovered during a network scan;
the plurality of ownership records include information about the plurality of assets entered when the assets were acquired; and
the matching rules specify at least a first field included in each of the plurality of discovery records to be matched with at least a second field included in each of the plurality of ownership records;
applying the matching rules to match one of the plurality of discovery records to one of the plurality of ownership records and create a matched record;
wherein the matched record includes a first pointer to the one of the plurality of discovery records and a second pointer to the one of the plurality of ownership records; and
wherein the one of the plurality of discovery records includes discovered information of an asset and the one of the plurality of ownership records includes ownership information of the asset.

2. The method of claim 1, wherein applying the matching rules includes comparing a first value in the first field with a second value in the second field to determine if the first value is an equivalent of the second value.

3. The method of claim 2, wherein applying the matching rules further includes comparing the first value with each of a plurality of entries in a translation table to determine if the first value is the same as any one of the entries in the translation table, wherein each of the plurality of entries in the translation table are a variant of the second value.

4. The method of claim 2, wherein applying the matching rules further includes comparing the second value with each of a plurality of entries in a translation table to determine if the second value is the same as any one of the entries in the translation table, wherein each of the plurality of entries in the translation table are a variant of the first value.

5. The method of claim 1, further comprising:
repeating applying the matching rules to match other ones of the plurality of discovery records to other ones of the plurality of ownership records to create a plurality of matched records; and
generating a registration table listing each of the plurality of matched records.

6. The method of claim 5, further comprising displaying each of the plurality of matched records to a user to check the accuracy of each of the plurality of matched records.

7. The method of claim 1, further comprising:
repeating applying the matching rules until an attempt has been made to match each of the plurality of discovery records to the plurality of ownership records;
listing unmatched discovery and ownership records; and
displaying the listed discovery and ownership records to a user to allow the user to match the unmatched discovery records to unmatched ownership records.

8. The method of claim 1, further comprising applying at least a first filter to select the plurality of discovery records from a larger group of enterprise discovery records and to select the plurality of ownership records from a larger group of enterprise ownership records.

9. The method of claim 8, wherein the filter is chosen by a user from a list of filters including: geographic information, business information, user information, and asset information.

10. The method of claim 8, wherein the filter is created by a user.

11. The method of claim 1, further comprising:
repeating applying the matching rules until an attempt has been made to match each of the plurality of discovery records to the plurality of ownership records;
identifying at least one of the plurality of discovery records without a corresponding ownership record; and
generating a new ownership record corresponding to the at least one discovery record.

12. The method of claim 1, further comprising:
comparing at least a third field of the one of the plurality of discovery records to a corresponding fourth field of the one of the plurality of ownership records; and
if a third value contained in the third field is different than a fourth value stored in the fourth field, changing the fourth value to the third value.

13. The method of claim 1, further comprising:
repeating applying the matching rules until an attempt has been made to match each of the plurality of discovery records to the plurality of ownership records;
identifying at least one of the plurality of discovery records without a corresponding ownership record; and
receiving an instruction from a user to remove the at least one of the plurality of discovery records from a broken links list.

14. The method of claim 1, further comprising:
repeating applying the matching rules until an attempt has been made to match each of the plurality of ownership records to the plurality of discovery records;
identifying at least one of the plurality of ownership records without a corresponding discovery record; and
receiving an instruction from a user to remove the at least one of the plurality of ownership records from a broken links list.

15. A system to manage discovered information and ownership information for a plurality of assets, comprising:
a first database including a plurality of discovery records, the plurality of discovery records including information about a plurality of assets discovered during a network scan;
a second database including a plurality of ownership records, the plurality of ownership records including information about the plurality of assets entered when the assets were acquired;
a reconciler engine coupled for communication with the first and second databases, the reconciler including a processor operable to apply matching rules to match one of the plurality of discovery records to one of the plurality of ownership records and create a matched record, wherein the matching rules specify at least a first field included in each of the plurality of discovery records to be matched with at least a second field included in each of the plurality of ownership records;
wherein the matched record includes a first pointer to the one of the plurality of discovery records and a second pointer to the one of the plurality of ownership records; and
wherein the one of the plurality of discovery records includes discovered information of an asset and the one of the plurality of ownership records includes ownership information of the asset.

16. The method of claim 15, wherein the processor being operable to apply the matching rules includes the processor being operable to compare a first value in the first field with a second value in the second field to determine if the first value is an equivalent of the second value.

17. The method of claim 16, wherein the processor being operable to apply the matching rules further includes the processor being operable to compare the first value with each of a plurality of entries in a translation table to determine if the first value is the same as any one of the entries in the translation table, wherein each of the plurality of entries in the translation table are a variant of the second value.

18. The method of claim 16, wherein the processor being operable to apply the matching rules further includes the processor being operable to compare the second value with each of a plurality of entries in a translation table to determine if the second value is the same as any one of the entries in the translation table, wherein each of the plurality of entries in the translation table are a variant of the first value.

19. The method of claim 15, wherein the processor is further operable to:
repeatedly apply the matching rules to match other ones of the plurality of discovery records to other ones of the plurality of ownership records to create a plurality of matched records; and
generate a registration table listing each of the plurality of matched records.

20. The method of claim 19, further comprising a graphical user interface for displaying each of the plurality of matched records to a user to check the accuracy of each of the plurality of matched records.

21. The method of claim 15, further comprising:
wherein the processor is further operable to:
repeatedly apply the matching rules until an attempt has been made to match each of the plurality of discovery records to the plurality of ownership records; and
generate a listing of unmatched discovery and ownership records; and
a graphical user interface for displaying the listed discovery and ownership records to a user to allow the user to match the unmatched discovery records to unmatched ownership records.

22. The method of claim 15, wherein the processor is further operable to apply at least a first filter to select the plurality of discovery records from a larger group of enterprise discovery records and to select the plurality of ownership records from a larger group of enterprise ownership records.

23. The method of claim 15, wherein the processor is further operable to:
repeatedly apply the matching rules until an attempt has been made to match each of the plurality of discovery records to the plurality of ownership records;
identify at least one of the plurality of discovery records without a corresponding ownership record; and
generate a new ownership record corresponding to the at least one discovery record.

24. The method of claim 15, wherein the processor is further operable to:
compare at least a third field of the one of the plurality of discovery records to a corresponding fourth field of the one of the plurality of ownership records; and
if a third value contained in the third field is different than a fourth value stored in the fourth field, change the fourth value to the third value.

25. The method of claim 15, wherein the processor is further operable to:
repeatedly apply the matching rules until an attempt has been made to match each of the plurality of discovery records to the plurality of ownership records;
identify at least one of the plurality of discovery records without a corresponding ownership record; and
receive an instruction from a user to remove the at least one of the plurality of discovery records from a broken links list.

26. The method of claim 15, wherein the processor is further operable to:
repeatedly apply the matching rules until an attempt has been made to match each of the plurality of ownership records to the plurality of discovery records;
identify at least one of the plurality of ownership records without a corresponding discovery record; and
receive an instruction from a user to remove the at least one of the plurality of ownership records from a broken links list.

27. A reconciler engine for reconciling discovered information and ownership information for a plurality of assets, comprising:
a processor operable to:
apply matching rules to match a plurality of discovery records with a plurality of ownership records, wherein:
the plurality of discovery records include information about a plurality of assets discovered during a network scan;
the plurality of ownership records include information about the plurality of assets entered when the assets were acquired; and
the matching rules specify at least a first field included in each of the plurality of discovery records to be matched with at least a second field included in each of the plurality of ownership records; and
generate a matched record including a first pointer to one of the plurality of discovery records and a second pointer to one of the plurality of ownership records;
wherein the one of the plurality of discovery records includes discovered information of an asset and the one of the plurality of ownership records includes ownership information of the asset; and
memory coupled to the processor and operable to store the matched record.

28. The method of claim 31, wherein the processor being operable to apply the matching rules includes the processor being operable to compare a first value in the first field with a second value in the second field to determine if the first value is an equivalent of the second value.

29. The method of claim 28, wherein the processor being operable to apply the matching rules includes the processor being further operable to compare the first value with each of a plurality of entries in a translation table to determine if the first value is the same as any one of the entries in the translation table, wherein each of the plurality of entries in the translation table are a variant of the second value.

30. The method of claim 28, wherein the processor being operable to apply the matching rules includes the processor being further operable to compare the second value with each of a plurality of entries in a translation table to determine if the second value is the same as any one of the entries in the translation table, wherein each of the plurality of entries in the translation table are a variant of the first value.

31. The method of claim 27, wherein the processor is further operable to:
repeatedly apply the matching rules to match other ones of the plurality of discovery records to other ones of the plurality of ownership records to create a plurality of matched records; and
generate a registration table listing each of the plurality of matched records.

32. The method of claim 31, further comprising a graphical user interface for displaying each of the plurality of matched records to a user to check the accuracy of each of the plurality of matched records.

33. The method of claim 27, further comprising:
wherein the processor is further operable to:
repeatedly apply the matching rules until an attempt has been made to match each of the plurality of discovery records to the plurality of ownership records; and
generate a listing of unmatched discovery and ownership records; and
a graphical user interface for displaying the listed discovery and ownership records to a user to allow the user to match the unmatched discovery records to unmatched ownership records.

34. The method of claim 27, wherein the processor is further operable to apply at least a first filter to select the plurality of discovery records from a larger group of enterprise discovery records and to select the plurality of ownership records from a larger group of enterprise ownership records.

35. The method of claim 27, wherein the processor is further operable to:
repeatedly apply the matching rules until an attempt has been made to match each of the plurality of discovery records to the plurality of ownership records;
identify at least one of the plurality of discovery records without a corresponding ownership record; and
generate a new ownership record corresponding to the at least one discovery record.

36. The method of claim 27, wherein the processor is further operable to:
compare at least a third field of the one of the plurality of discovery records to a corresponding fourth field of the one of the plurality of ownership records; and
if a third value contained in the third field is different than a fourth value stored in the fourth field, change the fourth value to the third value.

37. The method of claim 27, wherein the processor is further operable to:
repeatedly apply the matching rules until an attempt has been made to match each of the plurality of discovery records to the plurality of ownership records;
identify at least one of the plurality of discovery records without a corresponding ownership record; and
receive an instruction from a user to remove the at least one of the plurality of discovery records from the broken links list.

38. The method of claim 27, wherein the processor is further operable to:
repeatedly apply the matching rules until an attempt has been made to match each of the plurality of ownership records to the plurality of discovery records;
identify at least one of the plurality of ownership records without a corresponding discovery record; and
receive an instruction from a user to remove the at least one of the plurality of ownership records from a broken links list.
